(19) United States
(12) Patent Application Publication
(10) Pub. No.: US 2012/0057019 A1
(43) Pub. Date: Mar. 8, 2012

(54) Dynamic In-Situ Feature Imager Apparatus and Method

(75) Inventor: Alan Marchant, Hyrum, UT (US)

(73) Assignee: UTAH STATE UNIVERSITY, North Logan, UT (US)

(21) Appl. No.: 13/037,535

(22) Filed: Mar. 1, 2011

Related U.S. Application Data
(60) Provisional application No. 61/309,093, filed on Mar. 1, 2010.

(51) Int. Cl. H04N 7/18

(52) U.S. Cl. 348/135; 348/E07.085

(57) ABSTRACT

An optical scanning apparatus and method confocally image comparatively small features such as particles or bubbles in a relatively large volume. The main components of the apparatus include an illumination source and focusing optics, whose light is scattered to an optical sensor, typically an imager such as a camera, focal plane array, or the like. The illumination beam is focused such that its height is much less than its width, thus creating an almost planar or rectangular parallelepiped illuminated object space. The optical imager is positioned with its object-space focal plane parallel to the illumination beam such that the illumination beam passes through the in-focus object space of the imager. Images are collected while a fluid stream containing features of interest passes through imaging volume defined by the intersection of the in-focus object space and the illuminated object space.

### RELATED APPLICATIONS

This application claims the benefit of co-pending U.S. Provisional Patent Application Ser. No. 61/309,093, filed on Mar. 1, 2010 for DYNAMIC IN-SITU FEATURE IMAGER APPARATUS AND METHOD.

### BACKGROUND

1. The Field of the Invention

This invention relates to a method and apparatus for confocal imaging of small objects in a fluid stream, and in particular to the imaging of small features dispersed in a comparatively large volume.

2. The Background Art

The rapid, accurate, and real-time imaging of small objects or features in a fluid stream is important for a wide variety of health and environmental applications including in-situ imaging of particulates in air, examination of cells in a fluid culture, or characterization of particle flow in a fluid. Illumination methods affect dynamic imaging of a collection of features that are sparse, small, or both in a large fluid volume.

For example, screening blood units before blood transfusions is critical to detect bacterial contamination. Although national blood labs test the blood units before they are sent to hospitals for use, there is a need for analysis immediately before a transfusion. Visual inspection cannot detect microscopic contaminants. More detailed examination of the blood sample requires the preparation of slides and stains, culturing, or polymerase chain reaction (PCR) processing, all of which are costly in both time and labor. Medical tests such as blood cultures, spinal meningitis tests, and urinalysis involve the evaluation of small objects in fluids. These tests are relatively expensive, time consuming, and static.

Likewise, air quality monitoring seeks to detect and analyze the airborne particles that people breathe and particles detrimental to the environment. The particles are separated from the air, collected on filters for analysis, prepared on slides, and so forth, all of which is time consuming and static. Many pollutants are microscopic particles with characteristics shapes. Imaging the particles and identifying the shape can help determine the source of the pollutant. The ability to rapidly and accurately identify aerosols and airborne features is another area in which dynamic imaging of small features in a gaseous medium is desired.

In confocal imaging, an illuminator is coordinated and aligned collinearly with an image sensor. A beam of light is focused on a point within the sample volume and within the depth of focus of the imager. This point illumination technique uses a pinhole in an optically conjugate plane in front of the detector to eliminate out-of-focus information. It enhances the spatial resolution of the imager and reduces interference from features that lie within the sample volume but outside the common depth of focus shared by the illuminator and sensor. The increased resolution is obtained at the cost of decreased signal intensity. Long exposures and elaborate scanning are typically required.

A major deficiency in the confocal imaging technology is the extremely small size of the volume imaged, due to the point light source. In addition, the depth of focus is comparatively small. Therefore, a mechanical scanning method (e.g. rastering) is required to image any significant fraction of the sample volume. Current technology works well only when the sample volume is small and the features to be imaged are stationary. In addition, confocal imaging technology does not lend itself to the surveying of objects dispersed in fluids. Moreover, such static evaluation processes are not particularly useful or dynamic in surveying large volumes of fluids in-situ.

Therefore a system that provides illumination conditions that support the rapid detection and tracking of small features in a relatively large volume, especially a fluid free stream in-situ, including features that may be moving, is needed. Such a system that is capable of eliminating image confusion resulting from scattering from out-of-focus features is desired.

### BRIEF SUMMARY OF THE INVENTION

This invention relates to an optical scanning method and apparatus for the in-situ imaging, identification, and characterization of small particles in a relatively large volume. Illumination supports the detection and tracking of small features in a relatively large fluid volume, including features that may be moving within the sample medium.

The main components of the apparatus include an illumination source and focusing optics, aligned to cast a beam transverse to the line of sight of an optical imager. The illumination beam is concentrated such that its height is much less than its width, creating a thin box-like, almost planar, illuminated object space. The optical imager is positioned in coordination with the illumination with its object-space focal plane parallel to the projection direction of the illumination beam. The illumination beam passes through and fills a space within the in-focus object space of the imager. The depth-of-focus volume is positioned within a fluid of interest, in-situ. The illumination volume within the depth-of-focus volume scatters light from particles in-situ in the observed fluid and that light forms images on the image-space focal plane of the imaging system. Images are collected as a fluid stream containing features of interest passes through the intersection of the in-focus object space and the illuminated object space.

### BRIEF DESCRIPTION OF THE DRAWINGS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic image of a basic apparatus and method in accordance with the invention illustrating an illumination source, an imaging sensor such as a camera, and a confocal imaging volume in which the detector is imaging particulate matter in a flow transverse to the illumination;

FIG. 2 is a perspective view of one embodiment of a volumetric, confocal imaging system in accordance with the invention, illustrating the imaged volume and the illumination volume therewithin, for imaging by the sensor system;

FIG. 3 is a schematically imaged perspective view of a sample volume in which an illumination volume has been established within a focal volume or imaged volume of an apparatus and method in accordance with the invention;

FIG. 4 is a schematic block diagram of a process for confocal imaging of an illuminated volume of a fluid containing particles to be imaged;

FIG. 5 is an image from an apparatus in accordance with the invention;

FIG. 6 is an image recorded from the same apparatus, displayed at lower magnification;

FIG. 7 is an image likewise recorded in which a liquid carries particles through the field of view as multiple exposures occur; and

FIG. 8 is an image likewise recorded, in which the liquid is stationary during hundreds of illumination exposures.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

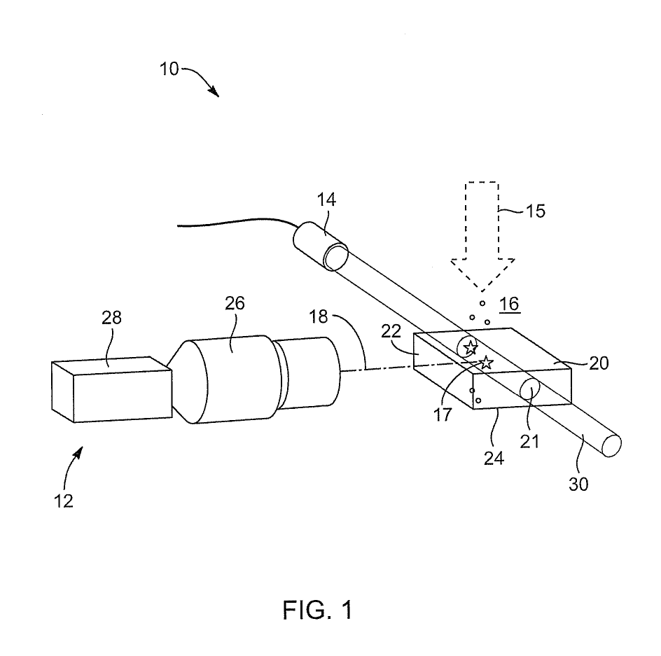

Referring to FIGS. 1-4, generally, while referring particularly to FIG. 1, an apparatus 10 or system 10 may be deployed to resolve particles of comparatively small size, including particles less than 5 microns in effective diameter. In general, an apparatus 10 in accordance with the invention may be used to image and otherwise characterize particle shapes, sizes, and the like in situ, in whatever transparent medium they may exist or flow.

For example, in situ may indicate a system imaging aerosol particles, pollutants, or any other contaminant or naturally occurring particulate matter in a flow of ambient air. For example, the flow of a sample may be air passing a tower, passing a building, passing by an aircraft carrying a system 10 in accordance with the invention, or the like.

Likewise, in certain embodiments, a flow of material that will become the object of examination may be a flow of a liquid, such as blood in a testing laboratory, other blood products, other fluids, whether plant, animal, or otherwise originating, and so forth.

In an apparatus and method in accordance with the invention, an apparatus 10 may include an imaging system 12 or imager 12. Typically, an imager 12 may include a camera imaging volume 20.

Referring to FIGS. 1-4, and more particularly to FIGS. 1-3, an apparatus 10 or system 10 may include an imaging system 12 operable in conjunction with an illumination system 14 illuminating a sample 16 viewed by the imaging system 12 along an axis 18, such as a line or axis of focus 18. Typically, in an apparatus 10 and method in accordance with the invention, the imager 12 may be focused at an imaging volume 20. The imaging volume 20 is comprised of an image area 22 bounded by edges 23a, 23b defined by the focal plane array, a pupil stop, or other optical components within the imager 12. That is, for example, the image area 22 and its edge dimensions 23a, 23b is defined by the field of view that the imager 12 is capable of including in its detector space or focal plane.

Likewise, the imager 12 is provided with a depth of focus 24 defined by the adjustment of the optics 26 through which an image is delivered to the camera 28, other sensor 28, or recorder 28 that forms the focal plane or exists in the focal plane of the imager 12. In one presently contemplated embodiment, the illumination system 14 or illuminator 14 provides a beam 30, such as a beam 30 of laser light. Typically, a source 32, such as a laser of any suitable type, having the power, wavelength, and so forth desired may be arranged to illuminate a portion of the imaging volume 20.

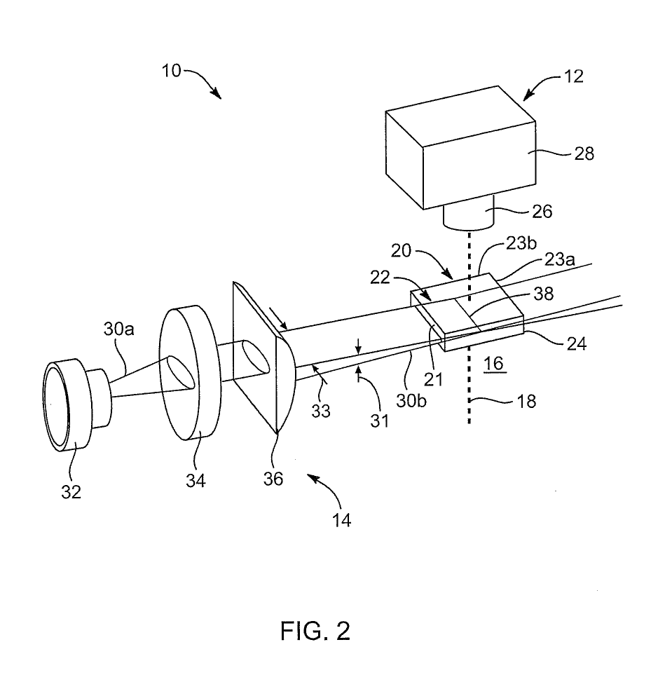

Referring to FIG. 2, while continuing to refer generally to FIGS. 1-4, the illumination system 14 or illuminator 14 may include, for example, a laser 32 or other source 32 of electromagnetic radiation such as coherent light. It has been found effective to pass the raw light beam 30a from the source 32 through a collimator 34 prior to a lens 36 or system 36 of lenses. In the illustrated embodiment, it has been found effective to pass a light beam 30a through a cylindrical lens 36 in order to form a very thin, but widely spread illumination beam 30b. The aspect ratio of the thickness 31 to the width 33 of the beam 30b is comparatively small Likewise, the thickness 31 of the beam 30b is sized to fit entirely within the depth of focus 24 when passing within the image area 22.

A benefit of maintaining the thickness 31 of the beam 30 within the dimension of the depth of field 24, is that no illumination is provided to any particles or features within the image area 22 that are outside of the focal region 24. Thus, the system 10 cannot be providing spurious information. In the illustrated embodiment, the beam 30 provides side or lateral illumination for the imaging volume 20 bounded by the depth of focus 24 and the image area 22.

By maintaining the thickness 31 of the beam 30 within the depth of field 24, the imager 12 is assured that all illuminated material is within the depth of field 24, and all imaged features of such illuminated material will be optically resolved. In contrast, if the thickness 31 of the beam 30 is permitted to exceed the depth of field 24, or be directed outside it, then there is no assurance that any imaged feature within the imaging area 22 is indeed a properly measured, imaged, calculated, resolved, or otherwise detected feature.

For example, for accurate and precise measurements of particles, whether being measured for illumination intensity, reflective intensity, size, shape, velocity, or the like, the optical system 26 and the camera 28, other sensor 28, or recorder 28 need to be combined with the knowledge of the flow, the volume, and so forth being imaged. In this way, the calibration of flows, and the interpretation of images received by the camera 28 may be assigned to a time, a location, a space, and indeed a volume as a known portion of the entire volume of a sample region or conduit.

In an apparatus 10 in accordance with the invention, the control and identification of the particular sample passing though the imaging volume 20 is used in order to properly characterize, identify, count, or otherwise observe the particles imaged by the camera 28. Accordingly, in an apparatus 10 and method 50 in accordance with the invention, the width 33 of the illumination beam from the illumination source 32 may be of any suitable width, so long as the width 33 is comparable to or greater than the edge dimension 23a or width 23a of the imaging volume 20. That is, if the width 33 of the beam 30 is much smaller than the dimension 23a of the image area 22, then a considerable portion of the image area 22 is not actually going to be imaged, because the sample 16 and the particles therein are not illuminated.

In contrast, the thickness 31 of the illumination beam 30b must fit within the depth of field 24 in order to assure that no portion of the sample 16 within the image area 22 is illuminated outside the depth of focus 24. This functional relationship is important in order to assure that no spurious imaging, reflected light, out-of-focus blur or the like may be detected by the camera 28 or sensor 28 through the optics 26 from outside the image volume 20. Any light reflected or scattered from the beam 30 into the focal plane of the camera 28 or sensor 28 must come from within the image volume 20.

If not, then the observations, such as counting, measuring, and the like and subsequent calculation of parameters characterizing particles will be incorrect. Thickness 31 outside the depth of field 24 adds spurious images not in the focal region. An illumination beam width 33 narrower than the width 23a of the image area 22 and thus the imaging volume 20 will leave un-illuminated, undetected particles that should have been detected, counted, imaged, or the like as part of the population passing through the imaging volume 20.

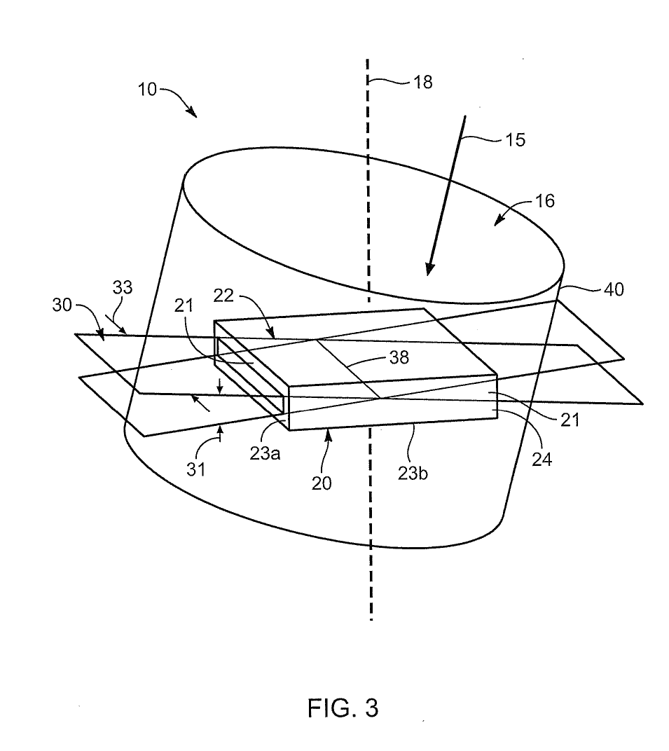

Referring to FIG. 3, while continuing to refer generally to FIGS. 1-4, an apparatus 10 or system 10 in accordance with the invention may benefit substantially from a velocity component transverse to the axis 18. The direction of flow of the sample 16 is best imaged and measured if a large portion of its velocity vector is transverse to the axis 18 of the optical system 26 of the imager 12.

For example, in imaging particles within the volume 16 of the samples 16 flowing past the image volume 20 of the system 10, calculations may be used to determine or characterize the population of the whole by referencing the population of the imaged volume 20. In the illustration of FIG. 3, the flowing sample volume 16 flows obliquely with respect to the sensor optical axis 18. Accordingly, a substantial velocity component exists in this flow of the sample 16, in the direction transverse to the optical axis 18. By pulsing the light source 32, the illumination beam 30 will be turned on and off at a known frequency. Meanwhile, particles within the image volume 20 will reflect light received from the beam 30, of which a certain amount of that reflected light will be reflected along the optical axis 18, through the optics 26 to be imaged by the camera 28 or other detector 28. By passing the flow in a direction that has a significant velocity component transverse to the optical axis 18, a strobed or pulsed source 32 serving the imager 12 will be providing illumination for sequentially imaging the image volume 20, such that multiple images of an individual feature are well separated on the image.

The strobe frequency or the cyclic frequency, net illumination time per cycle, power, wait time, and so forth may be controlled for the source 32, in order to provide distinct images. For example, too long a dwell time, or especially a continuous time period for the beam 30 may cause image smear or streaking images as a result of continuous detection of a particle in the image volume 20. Thus, strobing the source 32 may be used to great advantage by detecting certain individual particles within the image volume 20 as they pass through different depths within the depth of focus 24.

Certain individual particles may be illuminated multiple times while passing though the distance of the depth of field 24, and thus serve as markers to indicate velocity, and to provide input data to calculate the net flow of the sample 16, and the appropriate fraction thereof represented by the images captured by the imager 12 during their own dwell time within the image volume 20. Likewise, such markers can assure that the entire flow through the image volume has been imaged. Multiple exposure images also allow the system to characterize a large flowing sample volume on a single image without smear, and hence to maximize the information content of individual images. This is especially important when the sampling rate is constrained by a maximum camera frame rate.

Some of the benefits of an apparatus 10 and method 50 in accordance with the invention include the ability to provide confocal imaging, that is, a focusing of the light from the light source 32 into a beam 30 focused within a region that is also within the focus of the optics 26 and ultimately the focal plane of the camera 28 or other sensor 28 viewing the same focused region.

In the illustrated embodiment, a laser 32 may provide reflected or scattered light from the particles illuminated within the object space 20 or imaging volume 20 of the system 10. Likewise, a single detector may be used to provide timing or velocity information. Inasmuch as the rate of strobing or cycling of the light source 32 may be coordinated with the velocity of the flow of the sample 16, multiple images of a single particle occur at different locations as it passes through the imaging volume 20. Particularly, these occur as it passes through the depth of field 24, and more specifically through the thickness 31 of the illumination beam.

For example, the thickness 31 of the illumination beam 30 within the object space 20 or imaging volume 20 becomes the effective imaged region. Nothing in the field of view 22 can be “seen” or detected. Nothing outside the beam 30 is illuminated. Accordingly, an object or particle passing in any direction may be imaged in subsequently collected frames or images, thereby identifying the fact that all the flowed volume of the sample 16 passing through the imaged volume 20, has indeed been imaged.

Limiting the illumination beam 30, and particularly the thickness 31 thereof within the imaged volume precludes images of optics that are out of focus. That is, everything illuminated within the image volume 20 is within the depth of focus 24 or depth of field 24 of the imager 12.

By relying on side-scattered light only, the system may present a dark field behind the imaging volume 20. Away from the imaged volume 20 along the axis 18, and on the opposite side from the imager 12, only side-scattered light is detected by the imager 12. The resulting dark background maximizes the signal to noise ratio of the images.

In many applications, such as in atmospheric particulates, it is important to provide sensitivity in the imagerl2. Greater sensitivity is obtained by colder detectors in focal planes. However, illumination by backlighting adds substantial energy to the imager 12, and may oversaturate the focal plane. Thus, in an apparatus 10 and method 50 in accordance with the invention, dark backgrounds may be obtained, because the coherent light from a laser light source 32 is limited in its access to the imaging volume 20. It can reach the optics 26 and ultimately the camera 28 or sensor 28 of the imager 12 only by reflection or other scattering from the particles in the image volume 20. Thus, the sensors or the sensors forming the focal plane pixels within the imager 12 may be selected to be more sensitive, and may be operated at colder temperatures, because they will not be saturated by background light (e.g., blinded) from a source 32.

This last point is a substantial advantage of an apparatus 10 in accordance with the invention over conventional techniques for confocal imaging. Confocal imaging typically focus on a point, as small and narrowly defined as light diffraction principles will permit. The image space must then be rastered mechanically and optically in order to scan over the entire enclosed slide area of a fixed sample. Such confocal imaging has other problems. For example, the necessity to backlight renders more difficult the detection ability of sensitive focal planes arrays of an imager 12.

The volume 20 is controlled by the focus of the optics 26 of the imager 12. However, the actual viewed volume or the volume being illuminated is controlled by the light beam 30. Accordingly, it has been found best to control both the focal depth 24 or depth of field 24, and the thickness 31 of the beam 30, in order to gain the best control over the viewed volume, or the detected volume. As described above, the control of the width 33 along with the imaging area 22 or the image area 22 detected by the focal plane of the camera 28 also provides a jointly controlled region 22 or area 22 to be imaged. Thus, by maintaining the thickness 31 within the depth of field 24, and the width 33 extending at least to or beyond the width 23a of image area 22, an assurance of complete and accurate detection may be achieved.

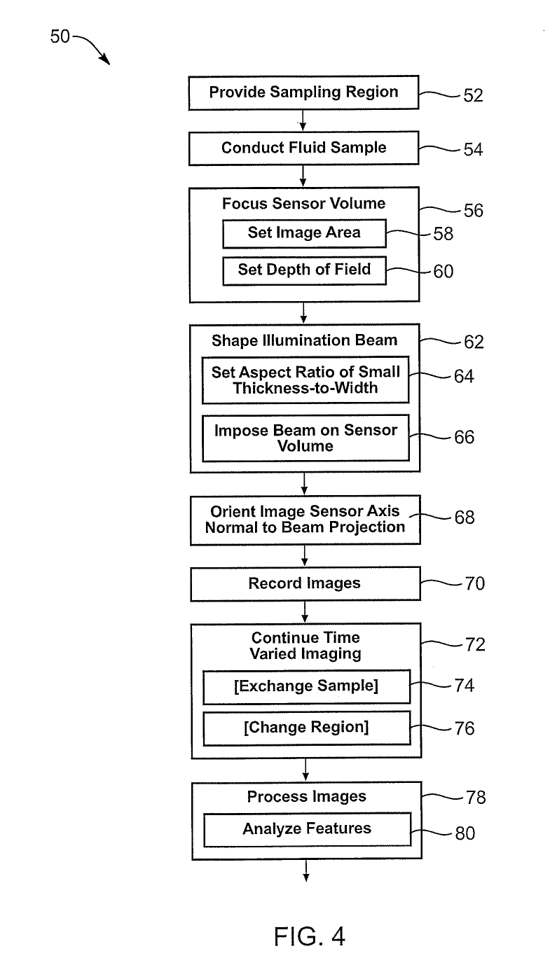

Referring to FIG. 4, another benefit of an apparatus 10 and method 50 in accordance with the invention is the continuous, uninterrupted flow of the sample fluid 16. For example, sampling in-situ may involve flying a detector on a balloon, an aircraft, a rocket, or the like. A detector 28 or camera 28 may be configured to operate near a stream or body of water. Similarly, in a medical context, a hospital may operate an apparatus 10 sampling blood or blood products prior to use.

By providing an in-situ measurement of the actual flow sample 16 in its environment, dynamically, as it is passed through a conduit, the method provides real-time monitoring in context. Filtering, sample preparation, slide preparation, fixation, and the like do not distort the results nor slow down the test processes. Thus, unlike other prior art systems, the sample 16 may be a continuous, uninterrupted flow, taken in-situ in the natural context of the material being evaluated.

Another way to think of in-situ observations is in terms of “free stream” flows. That is, for example, the atmosphere has some bulk direction as the winds blow. That free stream carries particulate matter. Similarly, a waterway, an aquifer, a body of water, or the like also presents a free stream or bulk region. Similarly, any process in a factory, or a hospital may also have a free stream flow of some material in a vessel, a conduit, or the like.

An apparatus 10 or method 50 in accordance with the invention permits in-situ observations of particles in the free stream of a sample 16. Thus, the lack of elaborate sample preparation and removal from context common to prior art measurement systems may be pushed toward a very free and natural context or limit.

One way to think of the apparatus 10 is as a system for isolating an Eulerian control volume within a dynamic flow. Accordingly, the image volume 20 presents an Eulerian control volume through which the sample 16 flows. By evaluation of the flow according to fluid dynamics principles, one may determine the volumetric flow rate, the flow profile, particle-dependent flow variations, and the like. Accordingly, the information obtained from the imaging of the known image volume 20 may be generalized across the entire free stream of the sample 16. This is in contrast to prior art systems with require either a fixed or a Lagrangian view. In a Lagrangian coordinate system, the coordinates of observation remain with the material being observed. This is very difficult to do in situ, although done in analytical systems. Nevertheless, it can be seen that prior art systems, especially in confocal imaging take the La Grangian view of locking in the material, and in fact rendering it a static sample.

In an apparatus and method in accordance with the invention, the pixels have been used at dimensions as small as a single micron in effective width, and optical resolutions finer than 5 microns have been obtained. Typically, a 3 micron resolution has been possible. Inasmuch as aerosols may have a size on the order of 0.1 to 100 microns, and inhalable dust particles typically extend to 10 microns in diameter, the resolutions available have been quite satisfactory. At this resolution the field of view of the imager 12 has been set as large as 2 millimeters by 3 millimeters. Typically, a few micro watts per pulse may be provided by the light source 32, and this energy may be adjusted with filters. Thus, high resolution, minimum control of the sample 16, and dynamic observations have been permitted in a confocal volume in an apparatus 10 in accordance with the invention.

Referring to FIG. 4, while continuing to refer generally to FIGS. 1-4, a method 50 in accordance with the invention may include providing 52 a sampling region. The sampling region, may typically be established by providing a conduit carrying a sample 12 past and through a volume 20 of focus and field of view, an imaging volume 20. The imaging volume 20 is defined by the image area 22 corresponding to the focal plane of an imager 12. For example, the focal plane array of a digital camera 28 will be established through optics 26 to include or image a region 22 of area 22 corresponding to the focal plane.

Likewise, a depth of field 24 may be established in order to both control the imaging volume 20, and to ensure a proper acuity or focus for presenting images. Typically, as the depth of field 24 is increased, the precision of the imaging decreases. As the depth of field 24 narrows, the degree of precision of the imaging increases. Thus, the depth of field 24 may be adjusted in order to trade off the precision of the optical imaging against the volume 20 that will be imaged.

Conducting 54 a fluid sample 16 may be done by arranging a conduit carrying the sample 16, such as a fluid carrying particulate matter through the space occupied by the imaging volume 20. Typically, such a conduit may be formed of any suitable material, and will typically be provided with transparent windows or be made of an optically transparent material. In certain embodiments, the imaging volume 20 may actually be located in the free stream of a fluid flow passing by the apparatus 10.

Focusing 56 a sensor volume 20 or imaging volume 20 may involve focusing the optics 26 in order to establish the imaging area 22 and depth of field 24. Accordingly, setting 58 the image area will establish and depend on the distances involved and the focus of the optics 26 in order to map or match the image area 22 to the focal plane of the camera 28 or other sensor 28.

Likewise, the depth of field 60 may be set 28 with the optics 26, according to the distance of the camera 28 from the imaging volume 20. The balance of precision and included volume (e.g. as per the depth of field 24) may be determined. That is, high precision requires tradeoffs, and in this case, one such trade is the volume that can be included within the depth of field 24.

Shaping 62 an illumination beam 30 involves the optical elements of the illumination system 14. The aspect ratio and the absolute size of the beam 30 may be set 64 in order to provide a thickness 31 that will fit within the depth of field 24. Meanwhile, as described above, the width 33 of the beam 30 ideally should completely fill the entire width 23a or edge 23a dimension of the image area 22 or focal area 22. Meanwhile, the beam 30 passes through the length 23b of the image area 22. Thus, the aspect ratio of thickness 31 to width 33, and the aspect ratio of width 33 to the length 23b of the image area 22 may be set by the distances and optics 26 of the apparatus 10.

Imposing 66 a beam on the imaging volume 20 or sensor volume 20 may be done continuously, but is often best served by a cycling approach. For example, a burst of light having a pulse energy, pulse duration, and pulse periodmay be coordinated with the particulate sizes expected. Accordingly, by reducing the length of the burst of light from the light source 32, improved resolution may be obtained as far as size is concerned. However, longer periods of illumination or longer bursts of light from the source 32 may result in additional illumination, which in some circumstances may be important for the purposes of detection at all.

For example, in liquids having some opacity or pigment, light transmissivity may be reduced. Meanwhile, in atmospheric air, transmissivity is usually not an issue. Accordingly, the imposing 66 of the beam may be adapted to the light transmissivity of the carrier material or the fluid in which the particulates are carried as the sample 16. It has been found suitable to flash comparatively short duty cycles of light, with longer pulse periods, and thus strobe the light source 32 in order to capture clean and precise images, that provide adequate illumination to the camera 28 or sensor 28.

Orienting 68 the image sensor axis 18 or optical axis 18 of the imager 12 is typically best done to provide a significant axial component of velocity in the flow 15 of the sample 16. For example, in the illustration of FIG. 2, no mention was made of the direction of flow of the sample 16. Typically, the orientation of FIG. 3 has been found most suitable. In the illustration of FIG. 3, the direction 15 or flow 15 of the sample 16 has a significant component of velocity along the optical axis 18 and a significant component of velocity transverse to the optical axis 18.

As particles pass through or along the depth of field 24, they may be imaged at different positions of depth therein. Accordingly, velocity may be measured. Perhaps more importantly, in many situations, one has the assurance that a particle has been captured at two depths of the volume 20. This imaging shows both an axial component of velocity along the depth of field 24 direction, as well as a cross component of velocity across the image area 22. Such multiple imaging assures that a particle may be detected at two locations, separated in distance of depth and distance transverse, or in a direction perpendicular to the optical axis 18.

This multiple imaging assures that the entire volumetric flow 15 of the sample 16 is sample by flow through the volume 20 being captured in multiple images. Meanwhile, the fluid dynamics of the flow 15 may be evaluated to determine the flow velocity profile and determine the overall passage of the sample 16. Its net content of particulate matter may thus be ascertained based on the sample taken in the imaging volume 20.

Typically, recording images 70 of any desirable precision may be done by the imaging system 12. The imager 12 may include, or be otherwise connected to a computer system in order to record data, maintain images, database records, and the like.

Continuing 72 the time varied imaging provides a sample to be taken of any desired significant size. Typically, data collection may be based upon the number of pulses from the light source 32, the velocity of the flow 15 passing through the depth 24 of the imaging volume 20, and so forth. Accordingly, one may optionally change 74 the sample, and possibly change 76 the sampled region.

In the illustrated embodiment of FIG. 3, such changes 74,76 may involve changing 74 the material that is the flow 15 constituting a sample 16, or changing 76 the region in which the object space 20 or imaging volume 20 is located within the flow. For example, in FIG. 3, the imaging volume 20 occupies a significant fraction near the center of the flow 15. In other environments, it may be valuable to sample across a region that is much larger than that illustrated, or in which the imaging volume 20 constitutes a considerably smaller portion of the flow 15.

Ultimately, processing 78 of images may involve analyzing 80 the various features desired to be detected. Meanwhile, the process 50 may be undertaken again in order to detect changes in the particulate content or the type of particulates in a particular sample 16 of a region being investigated.

The rapid, accurate, and real time imaging of small objects or features in a fluid stream is important for a wide variety of health and environmental related applications including in-situ imaging of particulates in air, examination of cells in a fluid culture, or characterizing the flow 15 of particles 17 in a fluid sample 16. Illumination methods are critical for the accurate imaging of a collection of small features 17 in a large fluid sample 16 volume.

Dynamic feature imaging in accordance with the invention may be applied to the rapid identification of bacterial contamination in blood units and other body fluids at hospitals. Such volumetric, confocal, high resolution imaging may be adapted to quickly screen a sample 16 of each blood unit nearer the moment a transfusion takes place. This imaging system 10 and technology may detect bacterial contamination before it enters the human blood stream. Other medical applications include rapid screening for spinal meningitis testing and urinalysis.

Imaging 70 particulates dispersed in air provides information about air quality and pollutants. Accurate and rapid imaging 70 is essential for the identification of the pollutant so remediation procedures can be implemented timely. Possibly even more important than pollutants, is real time detection and identification of airborne biohazards. The imaging systems 10 and methods 50 disclosed herein may monitor and detect hazardous biological pathogens such as weaponized anthrax and smallpox in air samples 16.

A feature 17 or object 17 can be a small solid particle 17, such as dust. Examples of features 17 inherent to the atmosphere may include fine soil particles, pollution particulates, and plant pollen. Other types of features 17 may include skin cells, tiny pieces of hair, and fibers originating from paper and textiles. A feature 17 can be a small gas bubble in a fluid sample 16 or a liquid droplet in the air. Additional examples of features include blood and tumor cells, platelets, bacteria, and biological pathogens. A feature 17 is a distinct object 17 with an effective diameter in the range of 1 to 100 microns. The above mentioned features 17 are presented for illustrative purposes and do not represent an all inclusive list of small objects that can be considered features 17.

A fluid stream 15 can refer to any flowing liquid, with water, oil, and blood being examples. The movement of air, hydrogen, oxygen, breath, or any other gas is also referred to as a fluid stream 15. A fluid stream 15 is characterized by the molecules of the fluid freely moving past one another and by the free motion of suspended matter 17. The fluid stream can be confined by a container or free to flow randomly. A fluid stream is, as used herein, is typically a dynamic or moving system, and may be a free stream in a bulk movement.

The present invention is an optical system 10 for imaging features 17 dispersed in a fluid medium 16. The optical components 26, 36 central to the functionality of the system are configured to create a relatively large volume 20 for in-focus imaging. The instantaneous imaged volume 21 may be substantially as large as the in-focus object-space 20 of the sensor. The spatial configuration of the optical components 26, 36, sensor 28, and sample volume 16 results in the minimization of image interference from features 17 outside the sensor depth of focus 24. The sample volume 16 refers to a volume of fluid containing features of interest.

In certain embodiments, the illumination source 32, as shown in FIG. 1, is directed and aligned by optical components 34, 36 such that the minimum-thickness region of the illumination beam 30 is centered with respect to the sensor optical axis 18. At a distance in front of the optical components 26, 36, the beam converges to a line of focus 38 and then diverges with increasing distance from the optical components 36 as illustrated in FIG. 2. This thinnest region of the illumination beam includes the area from just before the line of focus 38 to just after the line of focus 38. The illumination beam 30 geometry is such that the thickness 31 of the beam 30 within the region 21 of illumination is very small compared to the width 33 of the beam 30. An optical image sensor 28 is positioned such that the sensor optical axis 18 is normal to the illumination beam 30 and the thinnest region of the illumination beam 30 is within the sensor depth of focus. In one embodiment, for example, the specific optical and illumination components are selected such that the illumination beam 30 will fit within the depth of focus 24 of an optically fast sensor system 12 with a resolution smaller than 4 μm.

With continuing reference to FIG. 1, the illumination source 32 is a laser 32. The laser can be either continuous or pulsed. Other types of illumination sources may also be employed, such as incandescent lamps, electroluminescent lamps, gas discharge lamps, high-intensity discharge lamps, laser diodes, synchrotron radiation and the like. Additionally, non-visible light sources 32 that generate electromagnetic radiation 30 at infrared, ultraviolet, x-ray, and gamma ray wavelengths may be used. These other types of illuminators 32 may also be capable of pulsed operation.

The optical components, typically include a collimator 34 and cylinder lens 36. The collimator 34 performs its function of producing a parallel beam 30 of light. The cylinder lens 36 performs its function of focusing the light passing through it to a narrow strip 38.

The optical image sensor 28 is a device, such as a digital camera, for recording the observed features 17 in the illuminated portion 21 of the object space 20. The optical image sensor 28 may be a charge coupled device (CCD), a complementary metal oxide semiconductor (CMOS) active pixel sensor, or any other type of sensor capable of image capture.

The plenum chamber 40 containing or directing the flow 15 of the sample 16 may be a structure used to position the fluid medium containing the sample 16 to be imaged with respect to the illumination beam 30 and the sensor optical axis 18. The plenum 40 typically contains a port for the illumination beam and a port for the optical image sensor. Additional ports accommodate a flow channel to direct the fluid medium through the in-focus object space 20 of the sensor 12. The in-focus object space 20 of the optical image sensor 12 is defined as the three dimensional volume whose length and width are determined by the optical image sensor field of view 22 and the height of the depth of focus 24. The plenum chamber 40 aids in component orientation such that the illumination beam 30 is orthogonal to the sensor optic axis 18 and passes through the in-focus object space 20 within the plenum 40. The flow channel 40 directs the fluid medium containing the sample 16, at any angle, through the volume space defined by the intersection of the illumination beam 30 and the in-focus object space 20 of the sensor. Features 17 are imaged in the image volume space 21 defined by the intersection of the illumination beam 30 and the in-focus object space 20 of the sensor. This is the illuminated object space 21 of the system 10.

The optical system 10 described above may be used for high resolution imaging of features 17 in a sample volume 16. The steps for dynamic imaging are outlined in FIG. 4. An optical image sensor 12 is aligned so that its in-focus object space 20 lies within the sample volume 16. Optical components, for example a collimator 34 and cylinder lens 36, are positioned to shape an illuminating optical beam 30, originating from an illumination source 32, such that its thickness 31 is less than the depth of focus 24 of the optical image sensor 12 and its width 33 is at least comparable to the width 32a of the sensor field of view 22. The illuminating optical beam 30 is oriented to pass through the sample volume 16 within the in-focus object space 20 of the optical image sensor 12. This creates an illuminated object space 21, in which features in the sample volume are illuminated only while they are within the in-focus object space 20 of the optical image sensor 12. The optical image sensor 12 records the features 17 in the sample volume 16 that are in the illuminated object space 21 of the system 10. If the width 33 of the illumination beam 30 is smaller than the width 32a of the sensor field of view, the recorded optical image may exhibit feature shadowing effects due to the relative orientation of the illumination source and the image sensor.

This imaging method is capable of viewing sample volumes 16 much larger than the illuminated object space 21 of the system. One method to view a larger sample volume 16 is to translate the optical image system, thus moving the illuminated object space to a different region of the sample volume 16 via a scanning process. Another method to view a larger sample volume is to translate the sample volume 16 with respect to the illuminated object space of the system by fluid flow 15 of the sample medium. Once images are collected, a variety of methods may be employed to analyze the recorded features 17. For example, image analysis methods may identify particles of a particular shape or collect statistics on feature size distributions.

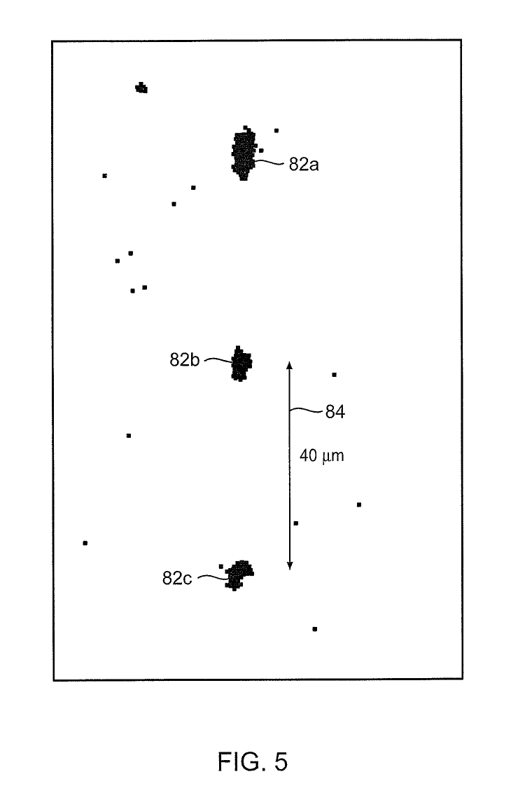

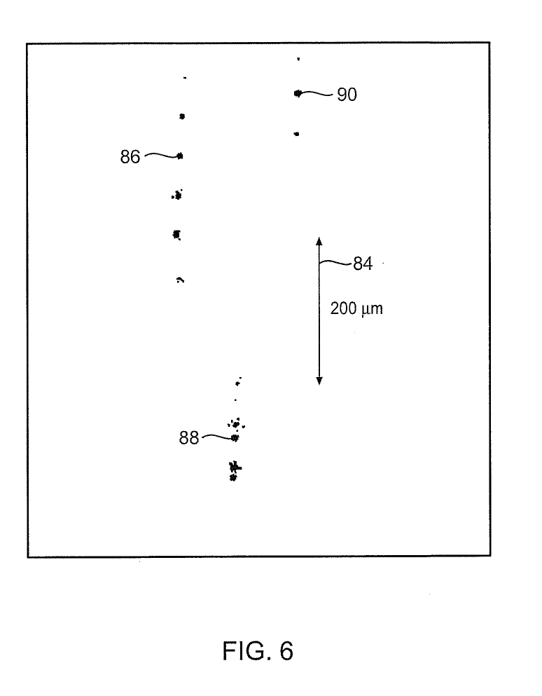

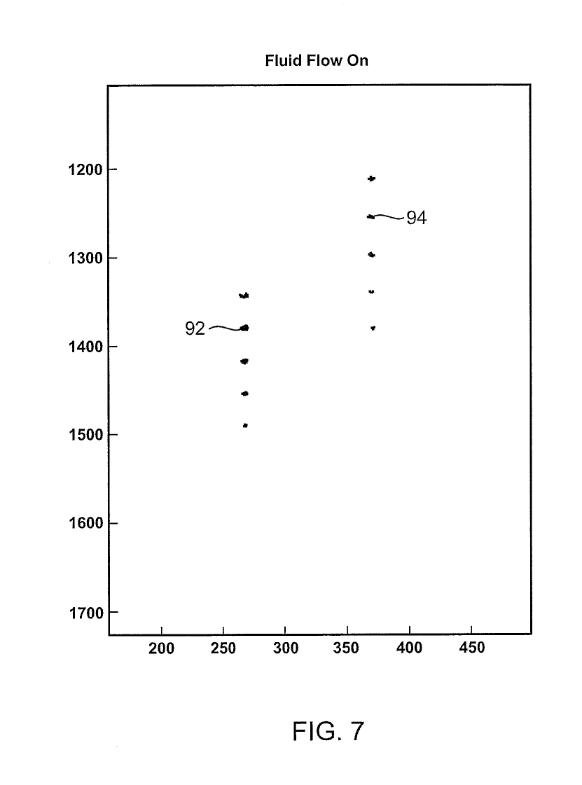

Referring to FIGS. 5-8, while continuing to refer generally to FIGS. 1-8, the optical system 10 and imaging methods 50 may characterize the motion of imaged features 17. The method for measuring the velocity of features requires collecting multiple images 82a, 82b, 82c of the same features 82, 86, 88, 90 in a fluid medium at known time intervals. The multiple images are analyzed to identify common features. The scaled length 84 shows distance in the images. The change in position of a common feature from one image 82a to the next image 82b, 82c is used to characterize their apparent motions. The velocity of a common feature 17 is determined by measuring its change in position over a known time. Multiple common features may be analyzed to measure the velocity or rotation of moving features 17 in a fluid medium 16. The shifting of images 82, 86, 88, 90, 92, 94 features across the image plane corresponds to velocity transverse to the optical axis 18 of the image sensor 12. The period of pulsed illuminatioin provides a measure of the velocity component parallel to the optical axis 18 of the image sensor 12.

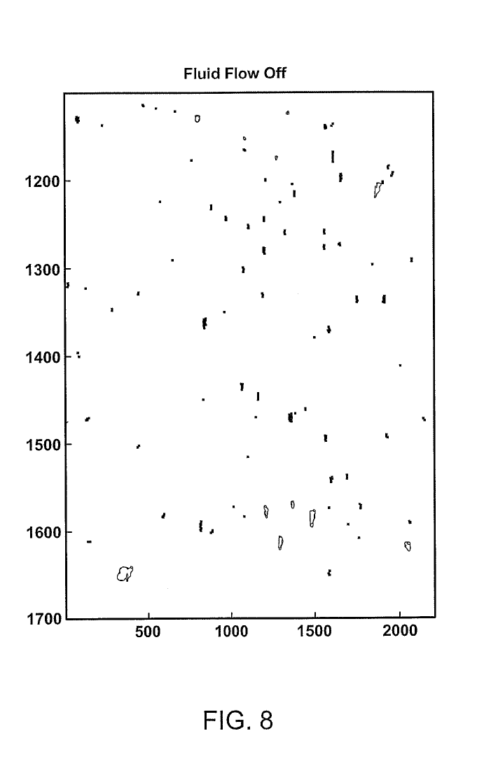

The optical system 10 and imaging methods 50 in a pulsed illumination mode may image large sample volumes and characterize feature motion parallel to the sensor optical axis 18. Large sample volumes 16 passing through the illuminated object space 21 are rapidly imaged by pulsing the illumination beam 30 at known time intervals and selected durations to create stop-action images 82, 86, 88, 90, 92, 94 of the features passing through the illuminated object space. For samples in which the features of interest are sparse, it may be advantageous to collect the stop-action images at multiple exposures as illustrated in FIGS. 5-8, where features show up multiple times. It is often important to provide a dark background to increase the contrast for the image sensor. FIG. 8 shows images of particles in a slow-moving fluid, each particle having been illuminated by hundreds of cycles of an illumination source 32.

The method for characterizing feature motion using the pulsed illumination mode requires pulsing the illuminating optical beam 30 at a sufficiently rapid rate to image a feature multiple times as it passes obliquely through the illuminated object space. Thus, lateral motion perpendicular to the sensor optical axis 18 also indicate, motion along the direction of the axis. The images are processed to determine the time for a feature to pass through the illuminated object space 21. Knowing the illumination pulse period and the orientation of flow space, one may determine velocity.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. An apparatus, imaging features in a fluid, the apparatus comprising:
an illumination source generating a first beam of light;
a beam-shaping structure focusing the light, along a beam axis, into a flat beam having a comparatively thin thickness and comparatively wide width, each normal to the beam axis;
a sensor, having an optical axis and comprising imaging optics and a detector;
the sensor, wherein the imaging optics are selected and adjusted to define a focal volume extending throughout a first area comprising a field of view and a first distance comprising a depth of field;
a flow channel directing the fluid through the focal volume in a first direction;
the beam shaping structure, focusing the flat beam such that the thickness thereof occupies not more than the first distance and is completely placed within the focal volume when passing by the first area;
the beam shaping structure, distributing the flat beam such that the width thereof extends within the area when passing through the focal volume; and
the sensor, positioned to record images corresponding substantially exclusively to the features in the fluid passing through an imaging volume comprising the intersection of the flat beam and the focal volume.

2. The apparatus of claim 1, wherein the illumination source is pulsed between an on condition providing the light and an off condition producing substantially no light.

3. The apparatus of claim 1, wherein the beam shaping structure comprises at least one of a mirror, a lens, and a collimator.

4. The apparatus of claim 1, wherein the imaging volume is positioned in the flow channel at a location calculated to sample the fluid passing through the imaging volume as a known fraction of the entire fluid flowing through the flow channel.

5. The apparatus of claim 1, wherein the imaging light consists essentially of reflected light, scattered from the features in the fluid, and originating from the flat beam.

6. The apparatus of claim 1, wherein:
the first area is planar, extending perpendicular to the optical axis; and
the first distance extends parallel to the optical axis.

7. The apparatus of claim 1, wherein the first direction is resolvable into an axial component passing through the imaging volume and a lateral component normal thereto, each of said components having a non-zero value and being within about an order of magnitude of one another.

8. The apparatus of claim 7, wherein:
the illumination source is a laser; and
the sensor is a camera.

9. An apparatus for imaging features in a fluid, the apparatus comprising:
a sensor detecting optical images;
optical components directing the optical images into the sensor;
an illumination source providing a beam creating the optical images;
a fluid flow channel conducting the fluid containing the features illuminated to create the optical images;
a plenum containing a first port, a second port, and a third port;
the plenum, wherein the first, second, and third ports are oriented such that when the illumination source is focused by the optical components, the beam passes through the first port;
the sensor, further positioned and focused through the second port on a focal volume defined by a field of view and depth of field thereof, the sensor confocally imaging substantially exclusively an imaging volume entirely within the focal volume and comprising an intersection of the beam and the focal volume; and
the fluid flow channel further shaped to pass through the imaging volume.

10. The apparatus of claim 9, wherein:
the illumination source is a laser;
the optical components include a collimator and a cylinder lens; and
the sensor is a digital camera.

11. A method for imaging features in a fluid, the method comprising:
identifying a first volume of the fluid;
focusing a sensor, receiving optical images, to define a field of view and depth of focus establishing a focal volume;
positioning the focal volume within the first volume;
shaping a beam for optical illumination to pass through the focal volume;
the shaping, wherein the width of the beam is at least substantially as wide as the field of view when traversing thereacross;
orienting the beam to pass through an image volume fitting within the depth of field and defined by the width and thickness of the beam passing through the focal volume; and
collecting, by the sensor, optical images formed by scattering the beam from features illuminated in the fluid exclusively within the image volume within the focal volume.

12. The method of claim 11, further comprising collecting additional images, after translating the first volume, to image, by the sensor, a new region of the first volume by moving the image volume therewithin.

13. The method of claim 11, further comprising scanning the first volume by translating the beam, image space and focus volume therewithin.

14. The method of claim 11, further comprising creating multiple stroboscopic exposures in an image of the sensor by pulsing the illumination source.

15. The method of claim 14, further comprising saving recordings of the stroboscopic images.

16. The method of claim 14, further comprising determining a characteristic of the features by analyzing the image.

17. The method of claim 11, further comprising:
providing an illumination source generating light;
providing a beam-shaping structure for focusing the light;
providing a sensor, having an optical axis and comprising imaging optics and a detector;
the providing the sensor, wherein the imaging optics are selected and adjusted to define the focal volume; and
providing a flow channel directing the fluid through the focal volume in a first direction.
